(19) United States
(12) Patent Application Publication
(10) Pub. No.: US 2025/0216744 A1
(43) Pub. Date: Jul. 3, 2025

(54) CAMERA MODULE INCLUDING APERTURE

(71) Applicant: Samsung Electronics Co., Ltd., Suwon-si (KR)

(72) Inventors: Kyung Sung CHU, Suwon-si (KR); Min Ook KIM, Suwon-si (KR); Dong Joon WON, Suwon-si (KR); Seung Hak LEE, Suwon-si (KR)

(21) Appl. No.: 18/758,357

(22) Filed: Jun. 28, 2024

(30) Foreign Application Priority Data
Dec. 28, 2023 (KR) 10-2023-0195178

(51) Int. Cl. G03B 9/06; G03B 9/26

(52) U.S. Cl. CPC G03B 9/06; G03B 9/26; G03B 2205/0069

(57) ABSTRACT

A camera module is provided. The camera module includes a lens assembly, a blade set disposed on an upper surface of the lens assembly and adjusting a diameter of a lens incident hole, a rotational drive part connected to the blade set and controlling movement of blades through a rotary motion, a blade connecting part connected to one side of the rotational drive part and rotating the rotational drive part, a linear moving part connected to the blade connecting part and accommodating a blade drive magnet on its outer side and a blade drive coil disposed opposite to the blade drive magnet, wherein in accordance with a current applied to the blade drive coil, the camera module adjusts a diameter of the lens incident hole by linearly moving the linear moving part within a blade drive aperture, which is disposed on a first side of a side frame.

### CROSS-REFERENCE TO RELATED APPLICATION

This application claims priority under 35 U.S.C. § 119 from Korean Patent Application No. 10-2023-0195178, filed on Dec. 28, 2023, in the Korean Intellectual Property Office, and all the benefits accruing therefrom under 35 U.S.C. § 119, the contents of which in its entirety are herein incorporated by reference.

### BACKGROUND

### 1. Field

The present disclosure relates to a camera module of an electronic device.

### 2. Description of the Related Art

With the development of information technology (IT), electronic devices equipped with camera modules, such as smartphones, tablet personal computers (PCs), laptops, and portable cams, are being widely distributed.

Camera modules are being miniaturized to be incorporated into electronic devices, while simultaneously incorporating various functions. Recently, there is a need in the mobile market and the miniaturized camera market to implement apertures comparable to those of digital single lens reflex (DSLR) cameras.

However, in the trend of electronic devices becoming lighter and smaller, it is difficult to implement a mechanical aperture in a narrow space. Additionally, since electricity needs to be applied to the yoke located near the coil for an aperture operation to fix the position of the magnets, there is an issue of power consumption even when the camera module is deactivated.

### SUMMARY

Aspects of the present disclosure provide a camera module that operates as a bistable drive system and includes an aperture using the repulsive force of magnets.

Aspects of the present disclosure also provide a camera module that includes blades capable of being fixed in two or more positions using the repulsive force of magnets, and that can be operated with low power.

Aspects of the present disclosure also provide a camera module that minimizes an increase in module height and head diameter by linearly operating a blade drive part.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a camera module comprising a lens assembly, a blade set disposed on an upper surface of the lens assembly and configured to adjust a diameter of a lens incident hole, a rotational drive part connected to the blade set and configured to control movement of blades through a rotary motion, a blade connecting part connected to one side of the rotational drive part and configured to rotate the rotational drive part, a linear moving part connected to the blade connecting part and accommodating a blade drive magnet on its outer side and a blade drive coil disposed opposite to the blade drive magnet, wherein in accordance with a current applied to the blade drive coil, the camera module is configured to adjust a diameter of the lens incident hole by linearly moving the linear moving part within a blade drive aperture, which is disposed on a first side of a side frame.

According to the aforementioned embodiments of the present disclosure, there is provided a camera module comprising a lens assembly, a blade set disposed on an upper surface of the lens assembly, including a plurality of blades, and configured to adjust a diameter of a lens incident hole, an iris cover plate disposed on an upper surface of the blade set and including an aperture at a position corresponding to the lens incident hole, a rotational drive part connected to the blades and configured to control movement of the blades through a rotary motion, a side base including a blade drive aperture on its first side facing the blade drive coil and a blade drive part configured to rotate the rotational drive part by being linearly moved along the blade drive aperture by the blade drive coil, to which a current is applied.

According to the other embodiments of the present disclosure, there is provided A camera module comprising a lens assembly, a blade set disposed on an upper surface of the lens assembly, including a plurality of blades, and configured to adjust a diameter of a lens incident hole for the lens assembly, a rotational drive part including internal fixed magnets, which are connected to the blades, configured to control movement of the blades through a rotary motion, and fix positions of the blades, a blade cover housing surrounding the rotational drive part and including a plurality of position-setting magnets on its inner sides, a blade drive coil to which a current is applied by a drive chip and a blade drive part configured to rotate the rotational drive part by being linearly moved in accordance with an amount of current of the blade drive coil.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a perspective view of a camera module according to example embodiments of the present disclosure.

FIGS. 2 and 3 are perspective views of the camera module of FIG. 1.

FIGS. 4 and 5 are a perspective view and a top view, respectively, of the camera module of FIG. 1.

FIG. 6 is a top view of the camera module with its aperture opened to a first stage, according to example embodiments of the present disclosure.

FIG. 7 is a top view illustrating the magnet arrangement of the camera module of FIG. 6.

FIG. 8 is a side view of the camera module of FIG. 6.

FIG. 9 is a top view of the camera module with its aperture opened to a second stage, according to example embodiments of the present disclosure.

FIG. 10 is a top view illustrating the magnet arrangement of the camera module of FIG. 9.

FIG. 11 is a side view of the camera module of FIG. 9.

FIG. 12 is a top view of the camera module with its aperture opened to a third stage, according to example embodiments of the present disclosure.

FIG. 13 is a top view illustrating the magnet arrangement of the camera module of FIG. 12.

FIG. 14 is a side view of the camera module of FIG. 13.

FIG. 15 is a diagram illustrating an exemplary electronic device including the camera module of FIG. 1.

### DETAILED DESCRIPTION

Hereinafter, example embodiments of the present disclosure will be described with reference to the accompanying drawings. Like reference characters refer to like elements throughout.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

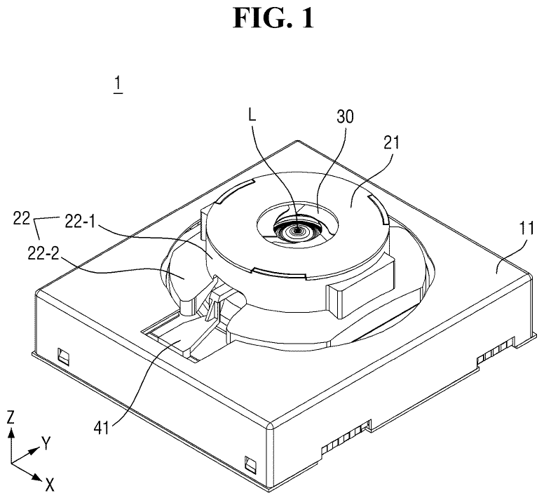

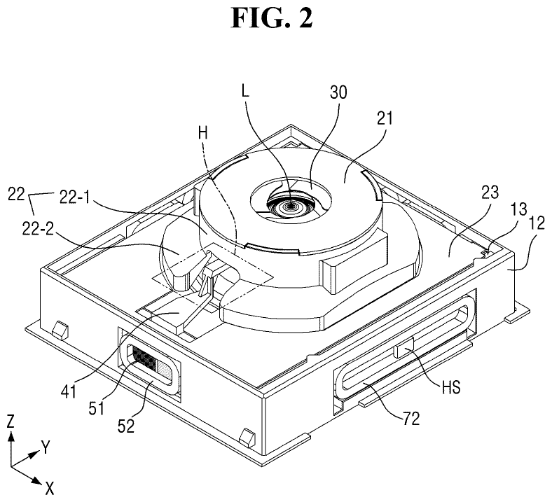

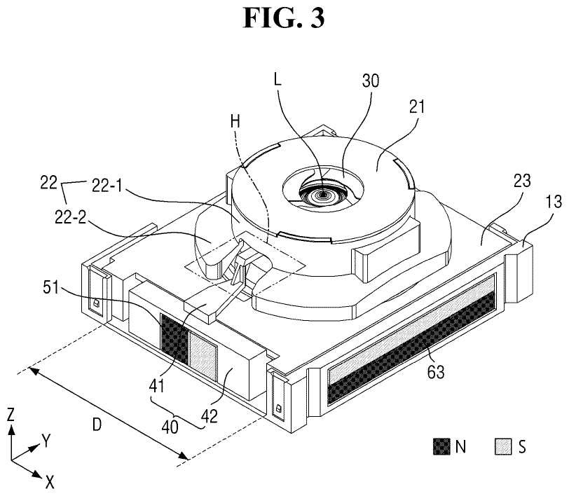

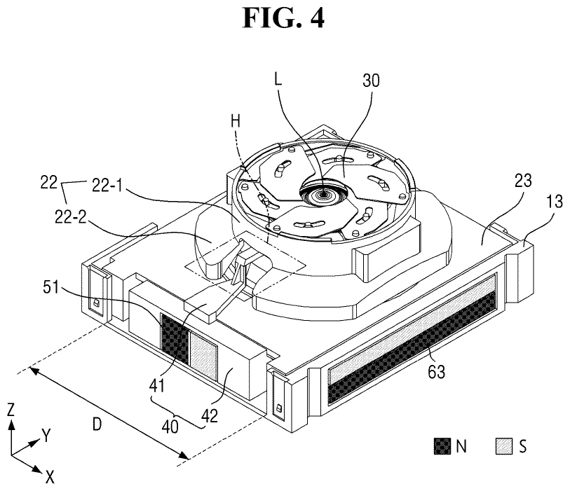

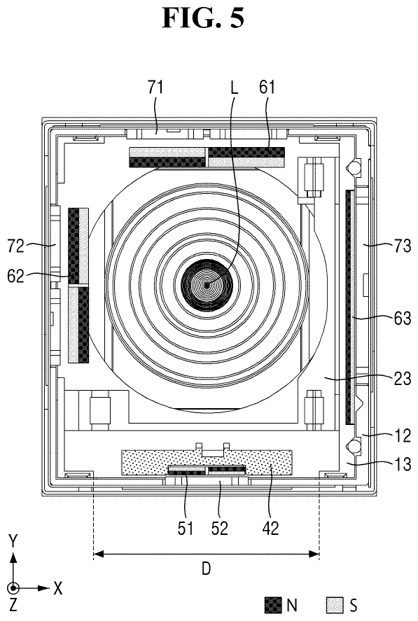

FIG. 1 is a perspective view of a camera module according to example embodiments of the present disclosure, and FIGS. 2 and 3 are perspective views of the camera module of FIG. 1. FIGS. 4 and 5 are a perspective view and a top view, respectively, of the camera module of FIG. 1.

Referring to FIGS. 1 to 5, a camera module 1 includes a module cover 11, an iris cover plate 21, a blade cover housing 22, a blade drive part 40, an auto focus (AF) drive part (AF drive magnet 63 and AF drive coil 73), an optical image stabilization (OIS) drive part (first OIS drive magnet 61, second OIS drive magnet 62, first OIS drive coil 71, and second OIS drive coil 72), and a side frame 12.

The module cover 11 may include an open aperture and may be provided to cover the camera module 1 from the top in a Z-axis direction. Through the aperture, a lens assembly L, a blade set 30, the iris cover plate 21, and the blade cover housing 22 are exposed. The aperture of the module cover 11 may have a fixed shape, such as a circular or polygonal shape, opened in the Z-axis direction, to prevent detachment of the lens assembly L.

The iris cover plate 21 includes an open aperture and covers the lens assembly L and the blade set 30 from the top in the Z-axis direction, and the blade cover housing 22 is formed to surround a rotational drive part. The diameter of the iris cover plate 21 and the aperture of the aperture of the iris cover plate 21 are smaller than the aperture of the module cover 11, and the diameter of the aperture of the iris cover plate 21 is greater than a hole formed by the blade set 30.

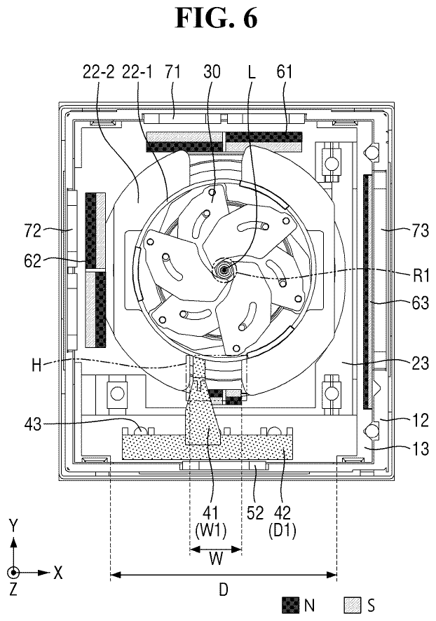

The blade cover housing 22 includes an upper member 22-1, which covers the lens assembly L and the blade set 30, and a lower member 22-2, which covers the sides of the rotational drive part and an internal base 23. The upper member 22-1 of the blade cover housing 22 may be formed in a cylindrical shape with a uniform diameter, including a protruding shape at a position where position-setting drive magnets are accommodated, and the lower member 22-2 may be formed in an outsert shape covering part of the internal base 23. The lower member 22-2 of the blade cover housing 22 includes a concave groove H. The concave groove H may be opened with a predetermined width W (see, e.g., FIG. 6) so that part of the blade drive part 40 is exposed, allowing the blade drive part 40 to move.

The module cover 11 may be formed of, for example, a metal material or a material having a hardness greater than a particular level (e.g., reinforced plastic).

Referring to FIG. 2, the camera module 1 includes the internal base 23, the side frame 12, a side base 13, the blade set 30, the blade drive part 40, the lens assembly L, an AF actuator (AF drive magnet 63 and AF drive coil 73), and the OIS actuator (first OIS drive magnet 61, second OIS drive magnet 62, first OIS drive coil 71, and second OIS drive coil 72) below the module cover 11.

The internal base 23 and the side frame 12 fix the internal components of the camera module 1, from above the camera module 1 in the Z-axis direction and from the sides of the camera module 1, respectively, to prevent detachment of the internal components of the camera module 1.

The lens assembly L may include one or more lenses and a lens barrel. The lenses may be moved up and down or tilted within the lens barrel to focus. The lenses may be moved by the AF drive part (AF drive magnet 63 and AF drive coil 73) or the OIS drive part (first OIS drive magnet 61, second OIS drive magnet 62, first OIS drive coil 71, and second OIS drive coil 72). Meanwhile, the lens assembly L may collect light incident from the outside and transmit the incident light to an image sensor placed on a printed circuit board (PCB) below the lens barrel. In some embodiments, one or more lenses may be implemented in the lens assembly L. The lens barrel may surround the lenses and may provide an optical path for transmitting the light incident through the lenses to the image sensor.

Referring to FIGS. 2 through 5, the side frame 12 is disposed to surround the sides of the camera module 1. The side frame 12 includes four apertures on its four sides, respectively, and drive coils disposed in the apertures. For example, a blade drive coil 52 of the blade drive part 40 is disposed on a first side of the side frame 12, an AF drive coil 72 and a hall sensor HS are disposed on a second side of the side frame 12, and first and second OIS drive coils 71 and 72 are disposed on third and fourth sides, respectively, of the side frame 12. In some embodiments, the third and fourth sides where the first and second OIS drive coils 71 and 72 are disposed may be adjacent sides, but not opposing sides. For example, if the third side extends in an X-axis direction, then the fourth side may extend in a Y-axis direction and may not be parallel to the third side in the X-axis direction.

The first side where the blade drive coil 52 is disposed and the second side where an AF drive coil 73 is disposed may be opposite to the third and fourth sides, respectively, where the first and second OIS drive coils 71 and 72 are disposed.

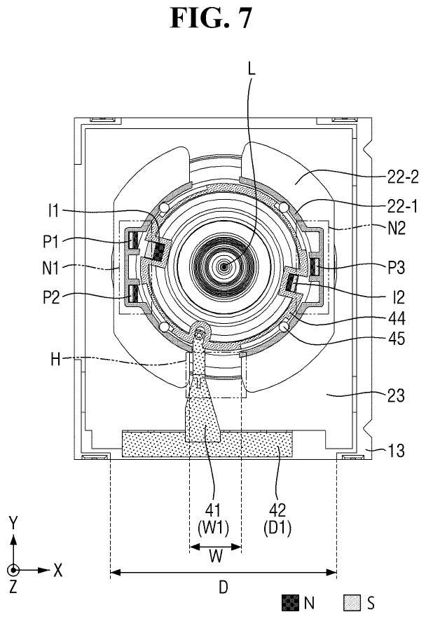

Referring to FIG. 3, the side base 13 is disposed on the inside of the side frame 12 to surround the sides of the camera module 1. An open blade drive aperture may be provided on a first side of the side base 13 to allow linear movement of the blade drive part 40. The blade drive aperture may be disposed to face the blade drive coil 52 of the side frame 12. The blade drive aperture may be opened to a width D (where D is a real number greater than 0) in the X-axis direction. The blade drive part 40, which has a smaller width than the blade drive aperture in the X-axis direction, may be disposed in the blade drive aperture and may be movable linearly along the X-axis direction. The blade drive part 40 may be fixed at each of a plurality of positions (for example, D1, D2, and D3) depending on the placement of first and second internal fixed magnets I1 and I2 (see, e.g., FIG. 7).

The blade set 30 may include a plurality of blades, for example, two wings or six wings. Alternatively, the blade set 30 may include 3, 4, 5, or N wings (where N is a natural number).

The blade drive part 40 may include a blade connecting part 41 and a linear moving part 42. The blade connecting part 41 connects the blade set 30 with the linear moving part 42. The blade connecting part 41 is fixedly connected to one side at the bottom of the blade set 30, and the blade set 30 may move according to the movement of the blade connecting part 41. As the blade connecting part 41 moves along the concave groove H, a plurality of wings may rotate in a predetermined direction (e.g., clockwise or counterclockwise). For example, as a result of the movement of the blade connecting part 41, the arrangement of the blade set 30 may be changed so that a lens incident hole may be changed. The lens incident hole is formed by the blade set 30 as an aperture above the lens assembly L, and the amount of light incident into the lenses from the outside may be regulated depending on a diameter R of the lens incident hole.

The linear moving part 42 includes a recessed receptacle on its first side, and a blade drive magnet 51 is disposed in the receptacle. For example, the blade drive coil 52 may be disposed on an external side facing the blade drive magnet 51. The blade drive coil 52 may be, for example, a bistable voice coil. By varying the current applied to the blade drive coil 52, the linear moving part 42 may move linearly along the blade drive aperture, and the blade connecting part 41 may move linearly along the concave groove H. The blade set 30 may adjust the size of the lens incident hole in accordance with the movement of the blade connecting part 41.

In some embodiments, the linear moving part 42 may include a moving element on its inner side facing the lens assembly L. For example, the moving element may be implemented as at least one ball to facilitate the movement of the linear moving part 42. A first side of the lens assembly L may further include a rail, which guides the movement of the moving element on the first side of the lens assembly L.

An AF drive magnet 63 may be disposed on the second side of the side base 13, and the first and second OIS drive magnets 61 and 62 may be disposed on the third and fourth sides, respectively, of the side base 13. The AF drive coil 73 may be disposed on the external side facing the AF drive magnet 63, the first OIS drive coil 71 may be disposed on the external side facing the first OIS drive magnet 61, and the second OIS drive coil 72 may be disposed on the external side facing the second OIS drive magnet 62.

The AF drive part (AF drive magnet 63 and AF drive coil 73) may control an AF operation by applying a current to the AF drive coil 73 and controlling the attraction/repulsion between the AF drive coil 73 and the AF drive magnet 63. The OIS drive part (first OIS drive magnet 61, second OIS drive magnet 62, first OIS drive coil 71, and second OIS drive coil 72) may apply separate currents to the first and second OIS drive coils 71 and 72, controlling the placement of the lenses in the X-, Y-, and Z-axis directions through the attraction/repulsion between the first OIS drive magnet 61 and the first OIS drive coil 71, and between the second OIS drive magnet 62 and the second OIS drive coil 72, to control an optical image stabilization operation for hand shaking or vibration.

In some embodiments, the blade drive magnet 51, the first and second OIS drive magnets 61 and 62, and the AF drive magnet 63 may be implemented as dual-pole magnets. For example, the blade drive magnet 51 and the first and second OIS drive magnets 61 and 62 may include multi-stage pole magnets with alternating polarities along the direction of movement. In some embodiments, a dual-pole magnet may be implemented such that opposite polarities may be combined on its front and back faces. If a magnet with an N pole (at its front face) and an S pole (at its back face) combined is a first stage and a magnet with an S pole (at its front face) and an N pole (at its back) combined is a second stage, a multi-stage pole magnet may be obtained by alternatively connecting first-stage pole magnets and second-stage pole magnets.

In some embodiments, the blade drive coil 52, the first and second OIS drive coils 71 and 72, and the AF drive coil 73 may be formed in a ring shape with a hollow center. In some embodiments, each of the blade drive coil 52, the first and second OIS drive coils 71 and 72, and the AF drive coil 73 may further include a hall sensor (not illustrated) in the center to sense positional changes between the corresponding drive coil and the corresponding drive magnet.

The PCB may include the image sensor, which is disposed on the upper surface of the PCB. The image sensor may be disposed on the PCB, corresponding to a lower portion of the lens barrel of the lens assembly L. The PCB may be electrically connected to a drive chip through a flexible board connected on one side of the PCB. The drive chip may receive power and control signals from the outside to supply power to the camera module 1, may generate camera module drive signals, and may transmit raw image data generated by the image sensor to an external device.

In some embodiments, the linear moving part 42 of the blade drive part 40 moves linearly along the blade drive aperture. For example, the blade set 30 may be opened in multiple stages. The diameter R of the lens incident hole will hereinafter be described as being adjusted in three stages, but the present disclosure is not limited thereto. Obviously, the blade drive part 40 may also be configured to adjust the diameter R of the lens incident hole in more than three stages.

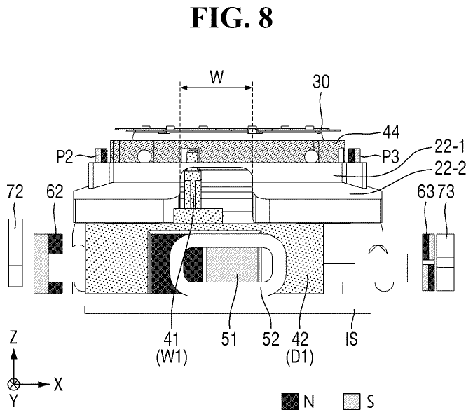

FIG. 6 is a top view of the camera module with its aperture opened to a first stage, according to example embodiments of the present disclosure. FIG. 7 is a top view illustrating the magnet arrangement of the camera module of FIG. 6, and FIG. 8 is a side view of the camera module of FIG. 6.

Referring to FIGS. 6, 7, and 8, at the first stage, the diameter R of the lens incident hole created by the blade set 30 may be set to R1. To set the diameter R of the lens incident hole to R1, the camera module 1 may adjust the current applied to the blade drive coil 52 so that the blade drive part 40 is disposed on one side of the blade drive aperture. For example, the blade connecting part 41 may be disposed on the left side, in the X-axis direction, of the concave groove H, and the linear moving part 42 may be disposed on the left side, in the X-axis direction, of the blade drive aperture.

The blade cover housing 22 may include a plurality of first, second, and third position-setting magnets P1, P2, and P3 on its inside. The blade cover housing 22 includes first and second outer recessed areas N1 and N2 on its inner surface. The first and second outer recessed areas N1 and N2 are, for example, disposed opposite to each other relative to the central axis of the lens incident hole, and the first, second, and third position-setting magnets P1, P2, and P3 may be accommodated in the first and second recessed areas N1 and N2. The first and second position-setting magnets P1 and P2 may be spaced apart within the first outer recessed area N1. Each of the first and second recessed areas N1 and N2 include three recesses of a uniform size. The first and second recessed areas N1 and N2 may have the same shape and the same number of recesses for the convenience of an assembly process for the camera module 1.

The first outer recessed area N1 may accommodate the first and second position-setting magnets P1 and P2 in two recesses on either side of a central recess. The second outer recessed area N2 may accommodate the third position-setting magnet P3 in a central recess.

The blade drive part 40 further includes a rotational drive part 44, which is connected to the ends of a plurality of blades. The rotational drive part 44 is connected to one end of the blade connecting part 41 and rotates within the upper member 22-1 of the blade cover housing 22 in accordance with the movement of the linear moving part 42. The rotational drive part 44 includes a moving member 45, which is disposed in the blade cover housing 22, and is thus moved by the moving member 45 when it rotates. The moving member 45 may be, for example, in the form of a ball.

The rotational drive part 44 includes a plurality of inner recessed areas, and the inner recessed areas accommodate first and second internal fixed magnets I1 and I2.

The blade drive coil 52 applies a current and thereby moves the linear moving part 42, utilizing the attraction or repulsion with the blade drive magnet 51. As the linear moving part 42 moves, the blade connecting part 41 also moves linearly, which in turn rotates the rotational drive part 44. Then, the rotation of rotational drive part 44 moves the blade set 30, thereby adjusting the diameter R of the lens incident hole. However, even if the linear moving part 42 moves, the position of the rotational drive part 44 is fixed due to the attraction between the first, second, and third position-setting magnets P1, P2, and P3 and the first and second internal fixed magnets I1 and I2. A current is applied to the blade drive coil 52 only when moving the linear moving part 42 during blade driving, and no current is applied when the position of the rotational drive part 44 is fixed. In this manner, power consumption for aperture adjustment can be minimized.

The rotational drive part 44, which is disposed on the upper surfaces of the lenses of the lens assembly L, includes two inner recesses. The inner recesses of the rotational drive part 44 are disposed opposite to each other based on the central axis of the lens incident hole, and the inner recesses accommodate the first and second internal fixed magnets I1 and I2. The first internal fixed magnet I1 is positioned and fixed to face either the first or second position-setting magnet P1 or P2 due to attraction or repulsion. The second internal fixed magnet I2 is positioned and fixed to face the third position-setting magnet P3 due to attraction or repulsion.

As illustrated in FIGS. 7 and 8, by moving the linear moving part 42 to the position D1, the blade connecting part 41 may be moved to a position W1 so that the first internal fixed magnet I1 of the rotational drive part 44 may be fixed due to the attraction with the first position-setting magnet P1. In other words, the first internal fixed magnet I1 of the rotational drive part 44 may be fixed, facing the first position-setting magnet P1 in the first outer recessed area N1, and the second internal fixed magnet I2 may be disposed to face a first side recess in the second outer recessed area N2, where the third position-setting magnet P3 is not present.

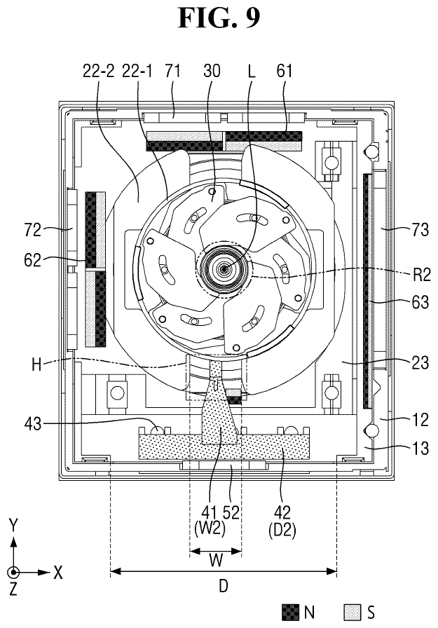

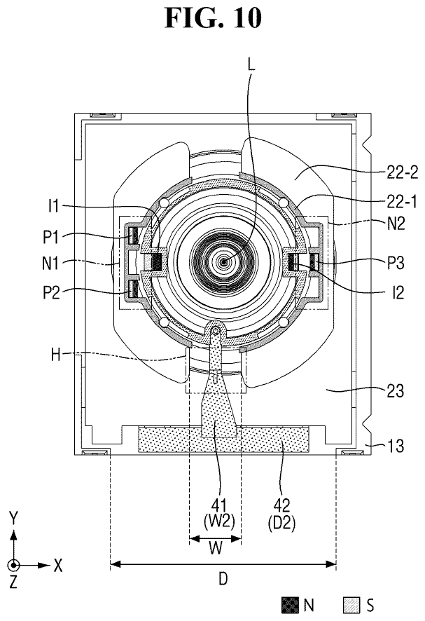

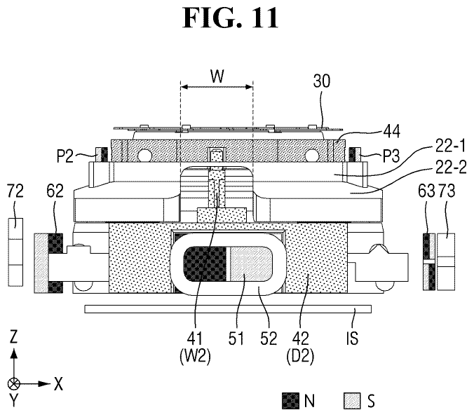

FIG. 9 is a top view of the camera module with its aperture opened to a second stage, according to example embodiments of the present disclosure. FIG. 10 is a top view illustrating the magnet arrangement of the camera module of FIG. 9, and FIG. 11 is a side view of the camera module of FIG. 9. For convenience, descriptions of content overlapping with what has been described above with reference to FIGS. 6 through 8 will not be repeated.

Referring to FIGS. 9, 10, and 11, at the second stage, the diameter R of the lens incident hole created by the blade set 30 may be set to R2, which is greater than R1 of FIG. 5. To set the diameter R of the lens incident hole to R2, the camera module 1 may adjust the current applied to the blade drive coil 52 so that the blade drive part 40 is disposed in the center of the blade drive aperture. For example, the blade connecting part 41 may be disposed at a position W2, which corresponds to a central part of the concave groove H, and the linear moving part 42 may be disposed at the position D2, which corresponds to a central part of the blade drive aperture.

As illustrated in FIGS. 9 and 10, by moving the linear moving part 42 to the position D2, the blade connecting part 41 may be moved to the position W2 so that the second internal fixed magnet I2 of the rotational drive part 44 due to the attraction with the third position-setting magnet P3. For example, the second internal fixed magnet I2 may be fixed, facing the third position-setting magnet P3 in the second outer recessed area N2, and the first internal fixed magnet I1 may be disposed to face the central recess between the first and second position- setting magnets P1 and P2 in the first outer recessed area N1.

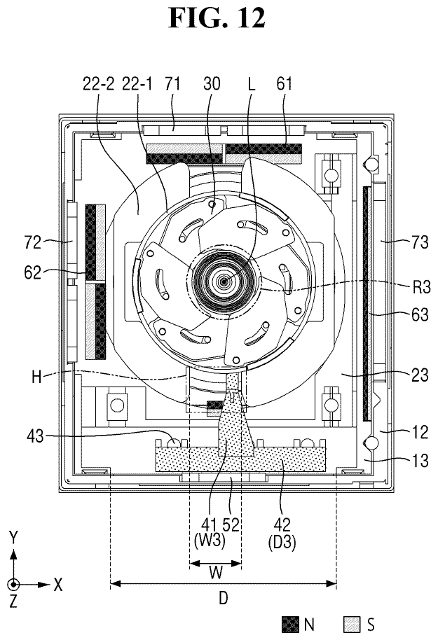

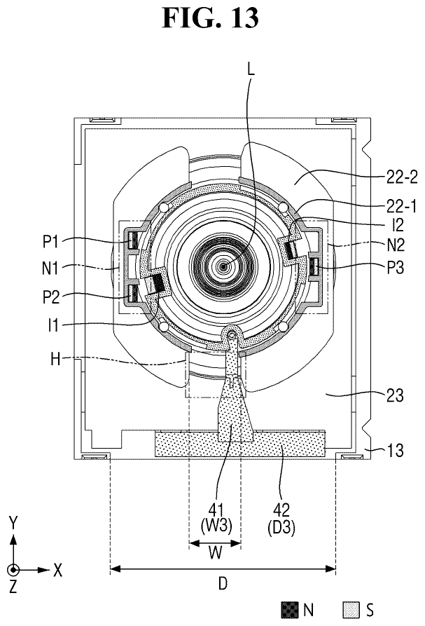

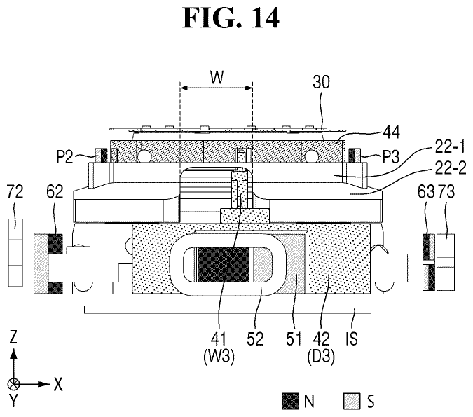

FIG. 12 is a top view of the camera module with its aperture opened to a third stage, according to example embodiments of the present disclosure, FIG. 13 is a top view illustrating the magnet arrangement of the camera module of FIG. 12, and FIG. 14 is a side view of the camera module of FIG. 13. For convenience, descriptions of content overlapping with what has been described above with reference to FIGS. 6 through 8 will be omitted.

Referring to FIGS. 12, 13, and 14, at the third stage, the diameter R of the lens incident hole created by the blade set 30 may be set to R3. R3 is greater than R1 of FIGS. 6 and R2 of FIG. 7. To set the diameter R of the lens incident hole to R3, the camera module 1 may adjust the current applied to the blade drive coil 52 so that the blade drive part 40 may be disposed on the other side of the blade drive aperture. For example, the blade connecting part 41 may be disposed on the right side, in the X-axis direction, of the concave groove H, i.e., at a position W3, and the linear moving part 42 may be disposed on the right side, in the X-axis direction, of the blade drive aperture, i.e., at the position D3.

As illustrated in FIGS. 13 and 14, by moving the linear moving part 42 to the position D3, the blade connecting part 41 may be moved to the position W3 so that the first internal fixed magnet I1 of the rotational drive part 44 may be fixed due to the attraction with the second position-setting magnet P2. For example, the first internal fixed magnet I1 of the rotational drive part 44 may be fixed, facing the second position-setting magnet P2 in the first outer recessed area N1, and the second internal fixed magnet I2 may be disposed to face a second side recess in the second outer recessed area N2, where the third position-setting magnet P3 is not present.

Thus, the camera module 1 can convert the linear motion of the linear moving part 42 into the rotational motion of the rotational drive part 44, thereby adjusting the aperture rate of the blade set 30. The blade drive part 40 is disposed on a side of the side frame 12 different from the sides where the OIS actuator (first OIS drive magnet 61, second OIS drive magnet 62, first OIS drive coil 71, and second OIS drive coil 72) and the AF actuator (AF drive magnet 63 and AF drive coil 73) are mounted. Since only a moving element or moving rail is needed for the linear motion of the linear moving part 42, this arrangement does not significantly affect the height, in the Z-axis direction, of the camera module 1 and minimizes the increase in head size. Moreover, power consumption for blade driving can be minimized by applying a current only during the adjustment of the lens incident hole and then fixing the position of the blade set 30 using the attraction and repulsion of magnets.

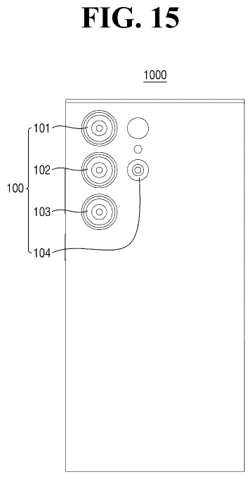

FIG. 15 is a diagram illustrating an exemplary electronic device including the camera module of FIG. 1.

Referring to FIG. 15, the camera module 1 may be embedded in an electronic device 1000. The electronic device 1000 may include, for example, at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, and a wearable device. Here, the wearable device may include at least one of an accessory-type device (such as, for example, a watch, a ring, a bracelet, anklets, a necklace, glasses, contact lenses, or a head-mounted device (HMD)) integrated into fabric or clothing (such as electronic apparel), a body-attached type (such as a skin pad or tattoo), or an implantable device (such as an implantable circuit).

The electronic device 1000 may also be, for example, a home appliance. Here, the home appliance may include, for example, at least one of a television (TV), a digital video disk (DVD) player, an audio system, a refrigerator, an air conditioner, a vacuum cleaner, an oven, a microwave, a washing machine, an air purifier, a set-top box, a home automation control panel, a security control panel, a TV box (such as, for example, Samsung HomeSync™, Apple TV™, or Google TV™), a game console (such as, for example, Xbox™ or PlayStation™), an electronic dictionary, an electronic key, a camcorder, and a digital photo frame.

The electronic device 1000 may be, for example, a vehicle. At least some of multiple vehicle cameras may include the camera module 1 of FIGS. 1 through 13. The vehicle may use the multiple vehicle cameras to provide the driver with various information regarding the interior or surroundings of the vehicle, and may automatically recognize objects or people in each video to provide information necessary for autonomous driving.

Referring to FIG. 15, the electronic device 1000 may be implemented as, for example, a mobile device, such as a smartphone. The electronic device 1000 may include a rear housing and a plurality of camera modules with different functionalities in a particular area. In the example of FIG. 15, the electronic device 1000 may include four camera modules, i.e., first through fourth camera modules 101 through 104, but the number and arrangement of camera modules in the electronic device 1000 may vary.

For example, the first camera module 101 may function as a main wide camera, the second camera module 102 as an ultrawide camera, and the third and fourth camera modules 103 and 104 as telephoto cameras.

The image sensor of the first camera module 101 may have a red-green-green-blue (RGGB) basic Bayer pattern, a Quad Bayer pattern with red-green-blue (RGB) arranged in a 2×2 layout, or a pattern of color filters that collectively form a Bayer pattern with RGB configured in a 4×4 layout. The size of the image sensor of the first camera module 101 may be greater than the image sensors of the second, third, and/or fourth camera modules 102, 103, and/or 104.

For example, the first camera module 101 may be implemented as the camera module of any one of FIGS. 1 through 13. However, the second, third, and fourth camera modules 102, 103, and 104 may not be implemented as described in FIGS. 1 through 13. In some embodiments, considering the reasonable cost and spatial constraints of each camera module, at least one camera module in a multi-camera module may be implemented as described in FIGS. 1 through 14. This configuration may consider an improvement in the performance of a camera that most significantly affects the image quality of each camera module.

Embodiments of the present disclosure have been described above with reference to the accompanying drawings, but the present disclosure is not limited thereto and may be implemented in various different forms. It will be understood that the present disclosure can be implemented in other specific forms without changing the technical spirit or gist of the present disclosure. Therefore, it should be understood that the embodiments set forth herein are illustrative in all respects and not limiting.

What is claimed is:

1. A camera module comprising:
a lens assembly;
a blade set disposed on an upper surface of the lens assembly and configured to adjust a diameter of a lens incident hole;
a rotational drive part connected to the blade set and configured to control movement of blades through a rotary motion;
a blade connecting part connected to one side of the rotational drive part and configured to rotate the rotational drive part;
a linear moving part connected to the blade connecting part and accommodating a blade drive magnet on its outer side; and
a blade drive coil disposed opposite to the blade drive magnet,
wherein the camera module is configured to adjust the diameter of the lens incident hole based on a current applied to the blade drive coil, by linearly moving the linear moving part within a blade drive aperture, which is disposed on a first side of a side frame.

2. The camera module of claim 1, wherein the camera module is configured to apply the current to the blade drive coil only when linearly moving the linear moving part.

3. The camera module of claim 1, wherein the rotational drive part includes internal fixed magnets.

4. The camera module of claim 3, wherein positions of the internal fixed magnets are fixed by attraction with at least one of a plurality of position-setting magnets.

5. The camera module of claim 4, further comprising:
a blade cover housing covering the lens assembly, the blade set, and the rotational drive part,
wherein the position-setting magnets are accommodated on an inside of the blade cover housing.

6. A camera module comprising:
a lens assembly;
a blade set disposed on an upper surface of the lens assembly, including a plurality of blades, and configured to adjust a diameter of a lens incident hole;
an iris cover plate disposed on an upper surface of the blade set and including an aperture at a position corresponding to the lens incident hole;
a rotational drive part connected to the blades and configured to control movement of the blades through a rotary motion;
a side base including a blade drive aperture on its first side facing a blade drive coil; and
a blade drive part rotating the rotational drive part by being linearly moved along the blade drive aperture by the blade drive coil, to which a current is applied.

7. The camera module of claim 6, wherein the blade drive part includes a blade connecting part, which is connected to the rotational drive part, and a linear moving part, which is connected to the blade connecting part and accommodates a blade drive magnet on its outer side facing the blade drive coil.

8. The camera module of claim 6, wherein the rotational drive part includes a first internal fixed magnet, which is accommodated in a first inner recess, and a second internal fixed magnet, which is accommodated in a second inner recess.

9. The camera module of claim 8, further comprising:
a blade cover housing covering the lens assembly, the blade set, and the rotational drive part and including a concave groove opened at a position corresponding to the blade drive part.

10. The camera module of claim 9, wherein the blade cover housing includes:
a first outer recessed area, which is formed on an inner side of an upper member; and
a second outer recessed area, which is formed on an inner side of the upper member and is disposed opposite to the first outer recessed area relative to a central axis of the lens incident hole.

11. The camera module of claim 10,
wherein each of the first and second outer recessed areas includes a plurality of recesses of a uniform size, and
wherein a position-setting magnet is accommodated in at least one of the recesses.

12. The camera module of claim 7, wherein the camera module is configured to apply the current to the blade drive coil when the linear moving part is moving and does not apply the current to the blade drive coil when the linear moving part is not moving.

13. A camera module comprising:
a lens assembly;
a blade set disposed on an upper surface of the lens assembly, including a plurality of blades, and configured to adjust a diameter of a lens incident hole for the lens assembly;
a rotational drive part including internal fixed magnets, which are connected to the blades, control movement of the blades through a rotary motion, and fix positions of the blades;
a blade cover housing surrounding the rotational drive part and including a plurality of position-setting magnets on its inner sides;
a blade drive coil to which a current is applied by a drive chip; and
a blade drive part rotating the rotational drive part by being linearly moved in accordance with an amount of current of the blade drive coil.

14. The camera module of claim 13, wherein the blade cover housing includes:
a first outer recessed area, which accommodates first and second position-setting magnets to be spaced apart and adjacent to each other, and
a second outer recessed area, which accommodates a third position-setting magnet at a position facing the first outer recessed area relative to a center of the lens incident hole.

15. The camera module of claim 14, wherein the internal fixed magnets fix a position of the rotational drive part based on attraction with one of the first, second, and third position-setting magnets when the blade drive part is linearly moved by an amount of current of the blade drive coil.

16. The camera module of claim 15, wherein the camera module applies the current to the blade drive coil when the blade drive part is moving and does not apply the current to the blade drive coil when the blade drive part is not moving.

17. The camera module of claim 13, wherein the blade drive part includes:
a blade connecting part, which is connected to the rotational drive part; and
a linear moving part, which is connected to the blade connecting part and accommodates a blade drive magnet on its outer side.

18. The camera module of claim 17, wherein the blade drive magnet and the position-setting magnets are dual-pole magnets.

19. The camera module of claim 17, wherein the linear moving part includes a moving element on its back side facing the rotational drive part.

20. The camera module of claim 17, wherein the blade cover housing includes a concave groove, which is opened to expose the blade connecting part.
